(19) United States
(12) Patent Application Publication
(10) Pub. No.: US 2002/0012459 A1
(43) Pub. Date: Jan. 31, 2002

(54) Method and apparatus for detecting stereo disparity in sequential parallel processing mode

(75) Inventor: Seung-Ho Oh, Seoul (KR)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: CHIPS BRAIN CO. LTD.

(21) Appl. No.: 09/886,294

(22) Filed: Jun. 21, 2001

(30) Foreign Application Priority Data
Jun. 22, 2000 (KR) 2000-34510
Apr. 26, 2001 (KR) 2001-22680

(51) Int. Cl. G06K 9/00

(52) U.S. Cl. 382/154

(57) ABSTRACT

A stereo disparity between a scanning image and a reference image is detected based on similarities measured by counting the number of pixels having lower differential brightness than a threshold in matched scanning windows. The matched scanning windows are centered at a scanning pixel within a scanning range, respectively. The matched scanning window has the same size with a reference window centered at a reference pixel. The scanning range is defined by the constraint related to the image-picturing conditions. The differential brightness is obtained by comparing the brightness of each pixel in each scanning window to that of each pixel in the reference window. An apparatus for detecting a stereo disparity comprises a strip-processing unit for calculating in parallel similarities of matched scanning columns in the scanning range to a reference column centered at the reference pixel. An S-buffer stores similarities calculated by the strip-processing unit. A WMC-unit calculates WMC values of matched scanning windows in the scanning range with respect to the reference window using the similarities of the matched scanning columns stored in the S-buffer. A Max_WMC selection unit selects the greatest value among WMC values calculated by the WMC-unit to output a shift from the scanning pixel corresponding to the reference pixel to the center pixel of the matched scanning window associated with the greatest WMC value as a disparity mark of the stereo disparity.

### TECHNICAL FIELD

This invention relates to a method and an apparatus for processing digital image, more particularly to the method and the apparatus for detecting a stereo disparity between two pixels belonging to different images by using a sequential parallel mode.

### BACKGROUND OF THE INVENTION

In the field of three dimensional vision or stereovision, stereo disparity estimation is a vigorously studied subject. Herein, “stereo disparity” refers to offset or disparity between a reference pixel and a scanning pixel, the reference pixel belonging to a reference image, the scanning pixel belonging to a scanning image, and both the reference pixel and the scanning pixel corresponding to a point in the physical space where the reference image and the scanning image are taken. The reference image is taken from the viewpoint of the left eye, while the scanning image is taken from the viewpoint of the right eye. In order to detect a scanning pixel corresponding to a selected reference pixel, coordinates for pixels in the two images are set. A window centered at the selected reference pixel is referred to as a reference window, while a window centered at a scanning pixel corresponding to the reference pixel is referred to be a matched scanning window, or simply a scanning window. The matched scanning window has the same area with the reference window. A scanning pixel in the matched scanning window corresponding to a selected reference pixel in the reference window is referred to as a matched scanning pixel. Similarity between reference pixels in the reference window and matched scanning pixels in the matched scanning window are calculated, respectively. A matched scanning pixel having the greatest calculated similarity is decided to be the scanning pixel corresponding to the reference pixel. A scanning pixel decided to correspond to a reference pixel is referred to as a corresponding scanning pixel. Thus, scanning pixels corresponding to all reference pixels in the reference image are decided, whereby a disparity map of the scanning image from the reference image is drawn. If the range of scanning pixels corresponding to a selected reference pixel is constrained in a horizontal row, which is identical to that of the selected reference pixel, the disparity map can be more easily drawn by using “the epipolar constraint”.

FIG. 1 shows a map including a scanning image graph and a reference image graph for explaining similarity calculation by using the epipolar constraint. In order to detect a scanning pixel in a scanning image corresponding to a selected reference pixel in a reference image, it is required to calculate similarities between matched scanning windows and the reference window centered at the selected reference pixel, the matched scanning windows centered at scanning pixels L along with a horizontal row being flush with the selected reference pixel R. Moreover, such a calculation has to be repeated many times to obtain the disparity map between a reference image and a scanning image. A difference between a shift of the corresponding scanning pixel and a shift of the reference pixel is referred to as a stereo disparity.

The epipolar constraint means the conditions that, in photographing two images by two cameras positioned at right and left sides in a two-dimensional camera coordinate system, a camera for taking the scanning image is positioned at the same height with the other camera for taking the reference image. In other words, two images in stereo are taken by two cameras, which nave the same attitude and central axes parallel to each other. The epipolar constraint is specified in an article “Structure from Stereo-A Review”, by U. R. Dhond and J. K. Aggarwal, IEEE Trans. Syst. Man Cybern., vol. 19, No. 6, pp.1489-1510, Nov./Dec. 1989.

Methods for calculating similarity between two pixels to detect the corresponding pixel are exemplified, as follows: an SSD (Sum of Squared Differences) method in which differential brightness of two compared pixels is considered; an SAD (Sum of Absolute Differences) method in which the differential brightness is considered as in the SSD method; and an NCC (Normalized Cross Correlation) method in which correlation with adjacent pixels is considered. The disparity maps drawn using these methods are differently affected by the brightness of scanning pixel. As shown in FIG. 2, erroneous disparities are obtained around the boundary of an object because of a boundary overreach phenomenon that a disparity boundary is shifted from a portion with greater differential brightness to other portions with smaller differential brightness.

Therefore, a need for an apparatus and/or a method for detecting a stereo disparity without the boundary overreach phenomenon has been existed.

### SUMMARY OF THE INVENTION

The image processing techniques of the present invention involve a technique of measuring the similarity by counting the number of matched scanning pixels having similar brightness to the reference pixels rather than considering an absolute brightness of a scanning pixel in a scanning field. The number of matched scanning pixels in a matched scanning window is counted in a sequential parallel processing mode. These techniques provide stereo disparity detection free from the boundary overreach phenomenon. Hereinafter, the number of matched scanning pixels in a matched scanning window is referred to as a WMC (Window Matching Count).

According to the present invention, the stereo disparity between a scanning image and a reference image is detected based on the similarity therebetween. The similarities are measured by counting the number of pixels having lower differential brightness than a threshold in matched scanning windows. The matched scanning windows are centered at a scanning pixel within a scanning range, respectively. The matched scanning window has the same size with a reference window centered at a reference pixel. The scanning range is defined by the constraint concerned with image-picturing conditions. The differential brightness is obtained by comparing the brightness of each pixel in each scanning window to that of each pixel in the reference window.

In an aspect of the present invention, an apparatus for detecting a stereo disparity between a scanning image and a reference image is provided. The apparatus comprises a strip-processing unit for calculating in parallel the similarities of matched scanning columns in the scanning range with respect to a reference column centered at the reference pixel. An S-buffer stores the similarities calculated by the strip-processing unit. A WMC-unit calculates WMC values of matched scanning windows in the scanning range with respect to the reference window using the similarities of the matched scanning columns stored in the S-buffer. A Max_WMC selection unit selects the greatest value among WMC values calculated by the WMC-unit to generate a shift from the scanning pixel corresponding to the reference pixel to the center pixel of the matched scanning window associated with the greatest WMC value as a disparity mark of the stereo disparity.

It is preferred that the apparatus further comprises a WMC-updating unit for updating the WMC value of the current matched scanning window using the WMC value of the previous matched scanning window calculated by the WMC-unit and the similarities of the matched scanning columns stored in the S-buffer.

The strip-processing unit preferably comprises a plurality of S-units connected in parallel with each other. Brightness data of the matched scanning columns less than the number of the S-units can be inputted to a first S-unit and sequentially shifted to the next S-unit up to the last S-unit. The S-units calculate the similarity of each matched scanning column with respect to the reference column using differential brightness of pixels.

The first S-unit preferably comprises a serial/parallel converter for converting serial brightness data of pixels in the matched scanning column into parallel data output to the next S-unit. A differential-brightness processing unit is also provided to obtain differential brightness of pixels between the matched scanning column and the reference column. A comparator compares the differential brightness of pixels obtained by the differential-brightness processing unit to a threshold value. An adder is provided to accumulate outputs of pixels from the comparator. A D-flip-flop for is also provided to buffer outputs from the adder into the S-buffer.

Each of the S-units other than the first S-unit comprises a parallel/serial converter for converting parallel brightness data of pixels in the matched scanning column into serial data output to the next S-unit. These S-units also comprise a differential-brightness processing unit, a comparator, an adder and a D-flip-flop as in the first S-unit.

The S-buffer preferably comprise (Wₓ+1) units of S-registers for sequentially shifting the (Sr+1) similarities inputted from the strip-processing unit, wherein Wₓ is the number of pixels in a horizontal row of the matched scanning window, and wherein the value of Sr is obtained by subtracting the value of wx form the number of pixels in a horizontal row of the scanning range where

$$wx = \frac{{W}_{x} - 1}{2} .$$

Wₓ units of multiplexers are also provided to multiplex outputs of the S-registers. A counter outputs multiplexing control signals to the multiplexers after counting the similarity data inputted to the S-register.

The WMC-unit preferably comprises an adder for accumulating the similarities multiplexed by the multiplexers to output the WMC value.

The WMC-updating unit preferably comprises a subtracter and an adder. The subtracter is to subtract the similarity of the foremost column of the previous matched scanning window from the WMC value of the previous matched scanning window. The adder is to add the similarity of the rearmost column of the current matched scanning window to the WMC value of the previous matched scanning window to obtain the WMC value of the current matched scanning window.

In another aspect of the present invention, a method for detecting a stereo disparity between a scanning image and a reference image is provided. In the method, the similarities of all matched scanning columns centered at the scanning pixels in the scanning range to a reference column centered the reference pixel is processed in parallel. The similarities of all matched scanning columns are used in calculating WMC values of all matched scanning windows with respect to the reference window. After selecting the greatest WMC, a shift from the scanning pixel corresponding to the reference pixel to the center pixel of the matched scanning window associated with the greatest WMC value is set as a disparity mark of the stereo disparity.

In processing column similarities, differential brightness between a reference pixel in the reference column and a scanning pixel matched to the reference pixel is obtained. Then, the number of pixels having differential brightness lower than a threshold in the matched scanning column is counted. The number of pixels is set as the similarity of the matched scanning column.

In calculating the WMC values, the WMC values between the matched scanning windows and a reference window including the foremost column in the reference image is calculated using the equation below:

$$WMC ( x , y , d ) = {\sum }_{i = - wy}^{wy} S ( x + i , y , d )$$

wherein, wy represents (W_{y}−1)/2 and W_{y} represents the number of pixels in a column of the scanning window.

In calculating the WMC values, the WMC values between the matched scanning windows and another reference window not including the foremost column in the reference image using the equation below:

WMC(x,y,d)=WMC(x−1,y,d)+S(x+wx,y,d)−S(x−1−wx,y,d)

wherein, wy represents (W_{y}−1)/2 and W_{y} represents the number of pixels in a column of the scanning window.

### BRIEF DESCRIPTION OF THE DRAWINGS

The embodiments of the present invention will be explained with reference to the accompanying drawings, in which:

FIG. 1 shows a map for explaining how a scanning range and a matched window are defined in comparing a scanning image with a reference image, in which both a scanning image graph and a reference image graph are included;

FIG. 2 shows a map for comparing the result obtained by the WMC method according to the present invention with that obtained by a conventional SAD method, in which two disparity maps are included;

FIG. 3 shows a map for explaining overlapped calculations in comparing a scanning image with a reference image by a WMC method, in which two reference image graphs are included;

FIG. 4 shows a map for explaining how to avoid the overlapped calculations in a WMC method, in which four reference graphs are included;

FIG. 5 shows a block diagram of an embodiment of the apparatus for detecting a stereo disparity using a sequential parallel processing mode according to the present invention;

FIG. 6 shows a flow chart for explaining an embodiment of the method for detecting a stereo disparity using a sequential parallel processing mode according to the present invention;

FIG. 7 shows a detailed block diagram of a strip-processing unit shown in FIG. 5;

FIGS. 8A and 8B show a detailed block diagram of a S-unit shown in FIG. 7, respectively, in which FIG. 8A shows a first S-unit, and FIG. 8B another S-unit except for the first S-unit;

FIGS. 9A and 9B show a map including a scanning image and a reference image for explaining operation of the strip-processing unit, in which FIG. 9A shows a status in processing calculations for matched scanning columns to the foremost reference column, and FIG. 9B other statuses in processing calculations for matched scanning columns to each reference column except for the foremost;

FIG. 10 shows a detailed block diagram of an S-buffer shown in FIG. 5;

FIG. 11 shows a detailed block diagram of an S-register shown in FIG. 10;

FIG. 12 shows a map for explaining operation of the S-buffer;

FIG. 13 shows a map for explaining operation of the multiplexer of the S-buffer;

FIG. 14 shows a detailed block diagram of a WMC-unit shown in FIG. 5;

FIG. 15 shows a detailed block diagram of a WMC-buffer shown in FIG. 5;

FIG. 16 shows a detailed block diagram of a WMC-updating unit shown in FIG. 5;

FIG. 17 shows a detailed block diagram of a Max_WMC selection unit shown in FIG. 5;

FIG. 18 shows a detailed block diagram of a parallel maximum value selector shown in FIG. 17;

FIG. 19 shows a detailed block diagram of a comparative selector shown in FIG. 18; and

FIG. 20 shows a detailed block diagram of a comparison unit shown in FIG. 18.

### DETAILED DESCRIPTION OF THE INVENTION

Referring to the attached drawings, hereinafter, preferred embodiments of the apparatus for detecting a stereo disparity in a sequential parallel processing mode according to the present invention are explained.

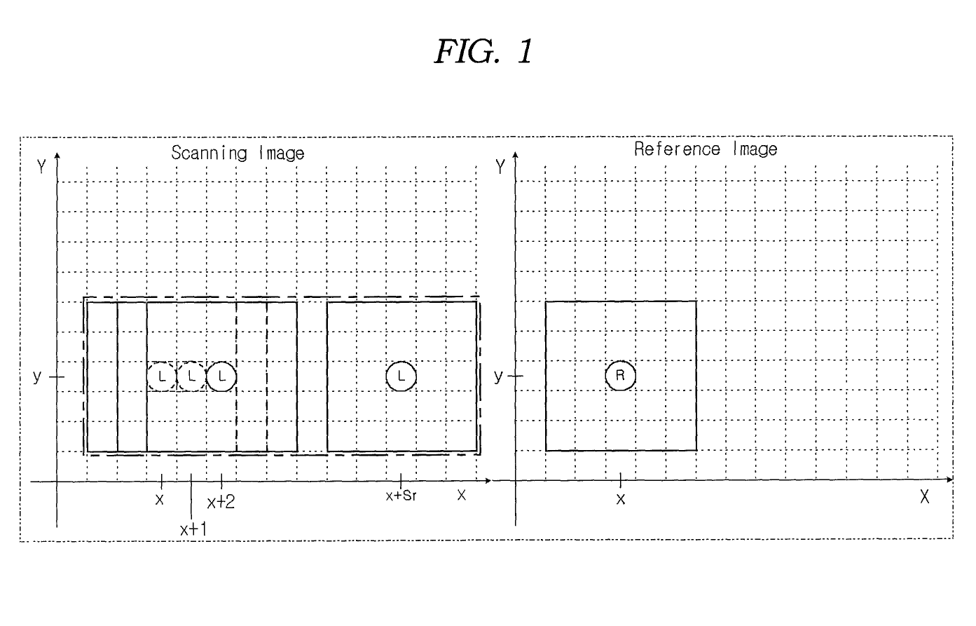

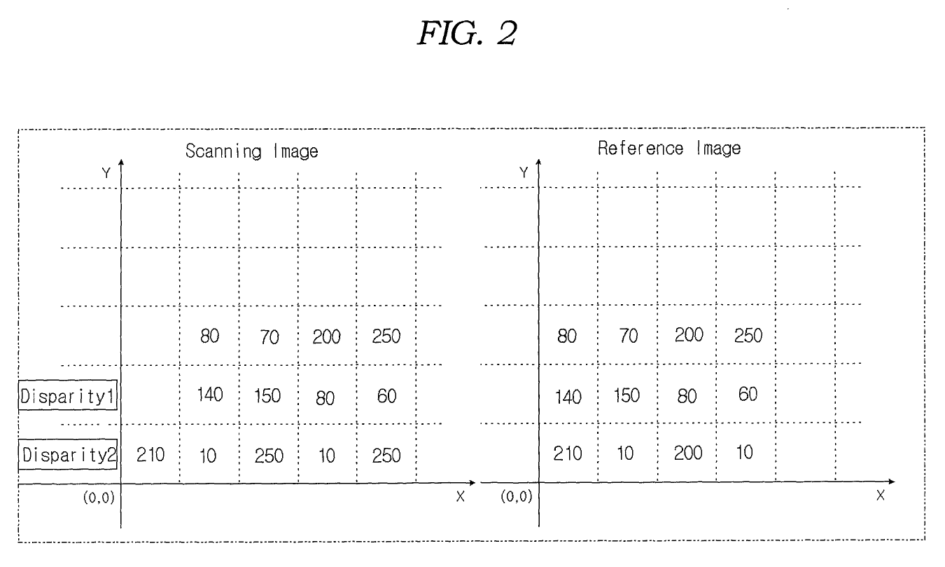

In FIGS. 1 through 4, lattices formed by horizontal dotted lines and by vertical dotted lines represent a pixel, respectively. An area enclosed by a dashed line represents a scanning range in relation with a reference pixel marked in each drawing. In the reference image, an area enclosed by a solid line and centered at the reference pixel R represents a reference window. In the scanning image, an area enclosed by a solid line and centered at the scanning pixel L represents a matched scanning window. A reference window consists of several reference columns, in which each reference column has a series of reference pixels in the vertical direction.

A WMC is used in measuring similarity of the matched scanning window in the scanning image with respect to the reference window in the reference image. Even at the boundary of the scanning image, very precise results may be expected because the brightness of pixels does not affect the similarity between pixels being measured.

In the case that the reference image and the scanning image are taken under the epipolar constraint, the WMC of the matched scanning window with respect to the reference window may be calculated from Equation 1.

$$WMC ( x , y , d ) = {\sum }_{W} P ( x , y , d ) \qquad ( 1 )$$

wherein, WMC(x,y,d) represents the WMC between a window centered at a pixel L(x+d,y) in the scanning image and a reference window centered at a pixel R(x,y) in the reference image, and “d” means the distance of the center of the current matched scanning window from the center of the first matched scanning window. The variable d varies from, 0 for the first matched scanning window to Sr for the last matched scanning window in the scanning range. P(x,y,d) represents the similarity of a matched scanning pixel to a reference pixel. The value of P(x,y,d) is set to 1, if the differential brightness of the matched scanning pixel with respect to the reference pixel is less than a given threshold, that is, |Y_{L(x+d,y)}−Y_{R(x,y)}|<Th, wherein Y_{L(x+d,y)} means the brightness of the pixel L(x+d,y), Y_{R(x,y)} the brightness of the pixel R(x,y), and Th the given threshold. Otherwise, the value of P(x,y,d) is set to 0. In other words, P(x,y,d) is 1 when the brightness Y_{L(x+d,y)} is similar to the brightness Y_{R(x,y)}, while P(x,y,d) is 0 when the brightness Y_{L(x+d,y)} differs from the brightness Y_{R(x,y)}. The variable W in

$${\sum }_{W}$$

means that accumulation of the values of P(x,y,d) is accomplished within a matched scanning window with a size of (Wₓ×W_{y}) in the scanning image.

After all of the values of WMC(x,y,d) in the scanning range, that is, for all values of the variable d from 0 to Sr, are calculated, the greatest WMC(x,y,d) is decided. The variable d for the matched scanning window with the greatest WMC(x,y,d) is determined as the disparity of the reference pixel R(x,y).

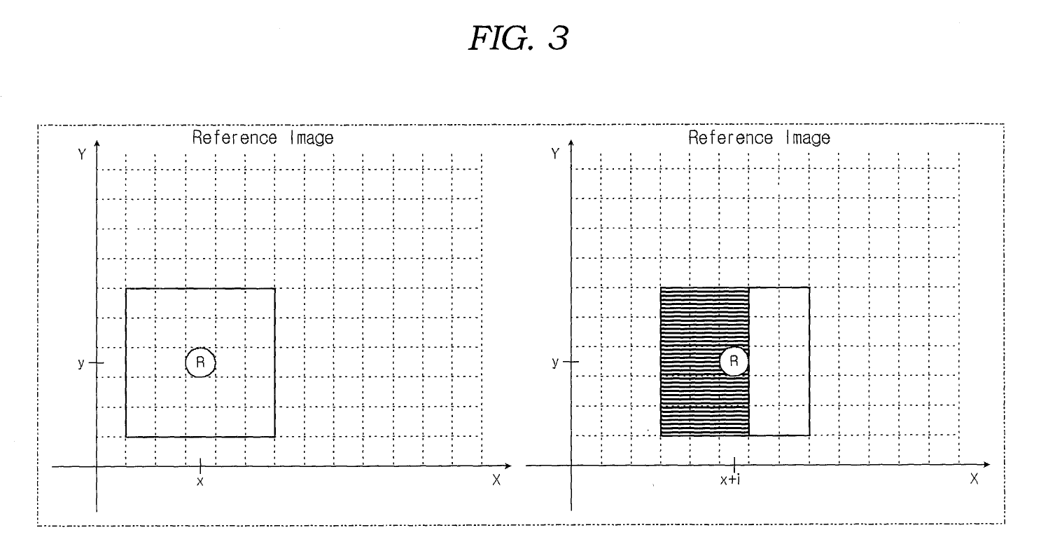

FIGS. 3 shows a map for explaining repetitive calculations to obtain all of the values of WMC(x,y,d) in the scanning range. Although the epipolar constraint is endowed, there is still a need for a large amount of calculation in proportion to the value of [(Ix×Iy)×(Wₓ×W_{y})×Sr], in which (Ix×Iy) means the size of the scanning image, and (Wₓ×W_{y}) the scanning window. These repetitive calculations excessively increase the quantity of process. When WMC values are calculated for a second reference pixel R(x+1,y), there are folded portions between the current matched scanning window and the previous matched scanning window for the first reference window. Therefore, the hatched portions in FIG. 3 are repetitively calculated. A buffer is used to avoid the repetitive calculations so that the quantity of process is in proportion only to the value of [(Ix×Iy)×Sr] regardless of the size of the window.

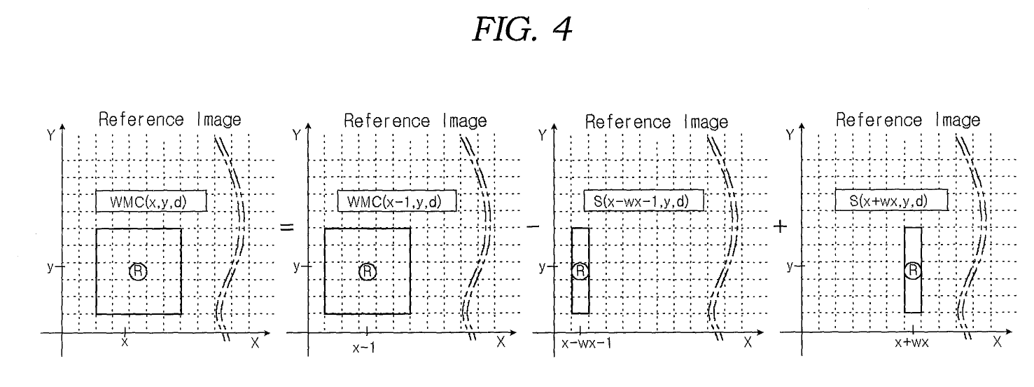

FIG. 4 shows a process map consisting of several reference coordinates for explaining a non-repetitive calculation process. The WMC of the matched scanning window with respect to the reference window can be calculated not only from Equation 1 but also from Equation 2.

$$WMC ( x , y , d ) = {{\sum }^{wy}}_{i = - wy} S ( x + i , y , d ) \qquad ( 2 )$$

wherein, S(x+i,y,d) represents the number of matched scanning pixels in a matched scanning column, that is, the similarity of the matched scanning column with respect to the reference column. The variable i varies within a range of −wy and wy. The value of wy and S(x+i,y,d) can be calculated from Equations 5 and 6 below, respectively.

The process shown in FIG. 4 can be represented by Equation 3. In other words, the WMC(x,y,d) of the matched scanning window with respect to the current reference window shifted from the previous reference window can be obtained using the WMC(x−1,y,d) of the matched scanning window with respect to the previous window calculated in step.

WMC(x,y,d)=WMC(x−1,y,d)+S(x+wx,y,d)−S(x−1−wx,y,d) (3)

As can be seen from Equation 3, WMC(x,y,d) for the current reference window is calculated by subtracting S(x−1−wx,y,d) for the earliest column in the matched scanning window with respect to the previous window from WMC(x−1,y,d) for the previous window and adding S(x+wx,y,d) for the last column in the current window thereto. Therefore, in this process, only for calculation of S(x+wx,y,d) is newly added.

In Equations 2 and 3, wx and wy, which mean the horizontal length and the vertical length from the center of the window to its periphery, are represented by Equations 4 and 5, respectively.

$$\begin{matrix}wx = \frac{{W}_{x} - 1}{2} & ( 4 ) \\ wy = \frac{{W}_{y} - 1}{2} & ( 5 )\end{matrix}$$

wherein, Wₓ means the horizontal length of the matched scanning window, and W_{y} the vertical length.

As can be seen from Equation 6 below. S(x,y,d) is calculated by adding the values of P(x,y+i,d) of pixels in a matched scanning column centered at a pixel L(x,y).

$$S ( x , y , d ) = {\sum }_{i = - wy}^{wy} P ( x , y + i , d ) \qquad ( 6 )$$

wherein, P(x,y+i,d) is 1 when the brightness of the matched scanning pixel L(x+d,y+i) is similar to the brightness of the reference pixel R(x,y+i), while the value of P(x,y+i,d) is 0 when the brightness of the matched scanning pixel L(x+d,y+i) differs from the brightness of the reference pixel R(x,y+i).

Equation 6 is repeatedly processed for the remaining portion of y, that is the portion in excess of wy, by the times corresponding the number of pixels in a column Iy except for the pixels in a column wy.

Herein after, a method for detecting a stereo disparity between the reference image and the scanning image according to a preferred embodiment will be more specifically explained.

S(x,wy,d) (hereinafter, referred to as an S-value or a strip value) is calculated from Equation 6, in which the values of x, y and d are within ranges of 0 through Wₓ, 0 through W_{y}, and 0 through Sr, respectively. All of the S-values (x,wy,d) of matched scanning columns to the number of (Sr+1), that is, S(x,wy,0), S(x,wy,1), S(x,wy,2), . . . , and S(x,wy,Sr), are calculated. A S-buffer having a size of the value of Wₓ×(Sr+1) is provided to store all of the S-values(x,wy,d). A value stored in each buffer cell is an integer obtained by rounding up the value of log₂Wₓ, which represents the similarity of a matched scanning column with respect to a reference column.

From Equation 2, WMC(x,y,d) is calculated by accumulating the S-values(x+i,y,d) into a WMC-buffer. The WMC(x,y,d) for the variable x in excess of wx is calculated using WMC(x−1,y,d) of the previous matched scanning window stored in the WMC-buffer, as can be seen from Equation 3 and FIG. 4.

In other words, the WMC(x,y,d) of the current matched scanning window can be easily calculated by adding S(x+wx,y,d) of a newly added matched scanning column, that is, a matched scanning column existing only in the current matched scanning window to WMC(x−1,y,d) of the previous matched scanning window, and subtracting S(x−wx−1,y,d) of an eliminated matched scanning window, that is, a matched scanning window existing only in the previous matched scanning window. The above processes are repeated by calculating WMC(x,y,d) for the variable y in excess of wy.

Briefly, all of the values of WMC are obtained by Equation 3 without any overlapped calculation. If WMC of a matched scanning centered at a scanning pixel is the greatest WMC for all matched scanning windows within the scanning range, the matched scanning pixel is referred to as a matched scanning pixel L(x+dₘₐₓ,y), and the dₘₐₓ is the stereo disparity of the reference pixel R(x,y).

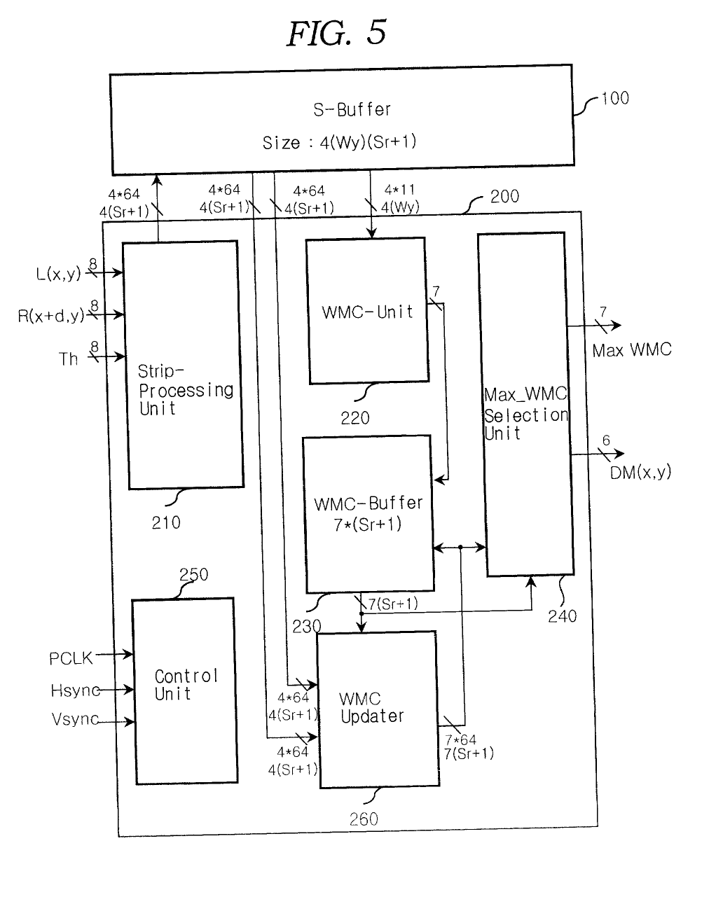

FIG. 5 shows a block diagram for explaining an apparatus for detecting a stereo disparity by calculating the WMC using a sequential parallel processing mode without any overlapped calculation according to this preferred embodiment of this invention. An example is provided to explain this embodiment, in which if the size of a matched scanning window is eleven pixels by eleven pixels, that is, both Wₓ and W_{y} are 11, respectively, the scanning range produces sixty four matched scanning window. In other words, the variable d varies from 0 to 63, that is, Sr, the greatest value of the variable d, is 63. Initially inputted are brightness data of reference pixels (referred to as R(x+d,y) in the drawings) and matched scanning pixels (referred to as L(x,y) in the drawings), a threshold (referred to as Th in the drawings), a horizontal synchronizing signal (referred to as Hsync in the drawings), a vertical synchronizing signal (referred to as Vsync in the drawings) and process clocks (referred to as PCLK in the drawings). The brightness data and the threshold are 8-bit signals, respectively. The greatest WMC(x,y,d) for a reference pixel R(x,y) and a disparity mark DM(x,y) are output in a 7-bit signal and in a 6-bit signal, respectively.

The apparatus for detecting a stereo disparity comprises a WMC-processor 200 and an S-buffer 100. The WMC-processor (200) consists of a strip-processing unit 210, a WMC-unit 220, a WMC-buffer 230, a WMC updater 260, a Max_WMC selection unit 240 and a control unit 250.

The strip-processing unit (210) having S-units to the number of (Sr+1) or 64 calculates 64 S-values, and then stores the results in the S-buffer 100. The WMC-unit 220 calculates WMC(x,y,d) by processing the results calculated by the strip-processing unit (210) and then stores the results in the WMC-buffer 230. The WMC updater 260 obtains an updated WMC. The Max_WMC selection unit 240 selects the greatest WMC inputted by the updater 260 and then outputs a disparity mark DM(x,y).

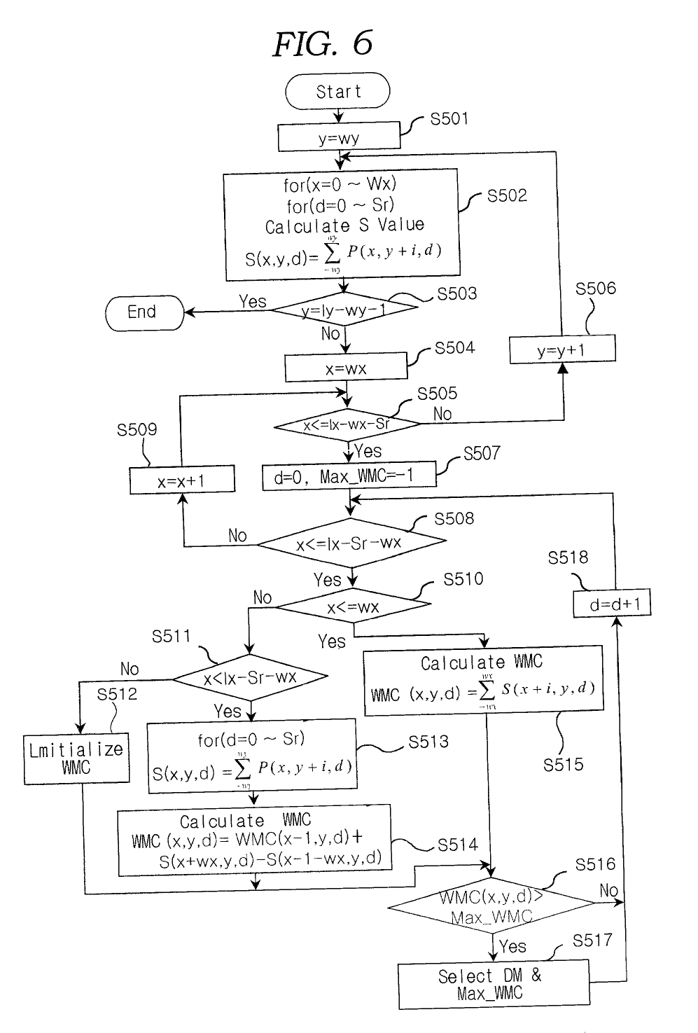

FIG. 6 shows a flow chart for explaining a method for detecting a stereo disparity using a sequential parallel processing mode using the apparatus shown in FIG. 5.

As can be seen from FIG. 6, brightness data of a reference pixel R(x,y) and a matched scanning pixel L(x,y) is stored in an external memory (not shown), in which the variable x varies from 0 to (Ix−1), and the variable y varies from 0 to (Iy−1). A window having a size of (Wₓ×W_{y}) and a scanning range Sr are set, in which both Wₓ and W_{y} should be set to odd numbers, respectively. A disparity mark DM(x,y) becomes an element of a stereo disparity including disparities for all of the pixels, wherein the variable x varies from wx to (Ix-wx-Sr), and the variable y from wy to (Iy-wy).

Each process of the algorithm shown in FIG. 6 will be more specifically explained below.

The variable y is initialized to a value wy (S501), in which the value of wy is calculated from Equation 4. S(x,y,d) of a matched scanning column is calculated using Equation 5, and then the results is stored in the S-buffer (S502), wherein the variable x varies from 0 to Wₓ, and the d varies from 0 to Sr. The number of buffer cells required to store the S-values (referred to as strip-values in other words) is the product of Sr by Wₓ, that is, Sr×Wₓ.

After checking the variable y in calculating WMC(x,y,d) (S503), all of the processes of the algorithm are finished when all of the values of WMC within the scanning range have been calculated, that is, y=1y−wy−1. Otherwise, processes for calculating the remained WMC proceed to the next step S504 where the variable x is initialized to a value of wx.

The processes are continued from the next step S505 for checking the variable x. If any uncalculated WMC on the associated row is remaining, that is, the variable x is smaller than the value of (1x-wx-Sr), the next step S507 for initializing both the variable d and the greatest WMC (hereinafter, referred to as Max_WMC) is performed. If the variable x is greater than the value of (1x-wx-Sr), the variable x is updated to the number increased by 1 (S506), and calculating process is returned to step S502.

After checking the variables d and x (S508), if the variable x is not greater than the value of (1x-wx-Sr), the next step S510 is conducted. Otherwise, the variable x is updated to the number increased by 1 (S509), and the processes are returned to step S505.

After checking whether the variable x is greater than that of wx (S510), if so, the processes proceed to the next step S511 to calculate the current WMC using the previous WMC. If not, the processes proceed to another step S515 to calculate a serial WMC using Equation 2, and then proceed to the next step S516. After checking whether the variable x is less than the value of (1x-Sr-wx) (S511), if so, the current WMC is calculated using Equation 3 (S514), and then the processes proceed to the next step S516. If not, the WMC is set to 0 (S512), and then the processes proceed to the next step S516.

If the current WMC is greater than Max_WMC stored in the WMC-buffer (S516), Max_WMC is updated to the current WMC, and the variable d associated with the updated Max_WMC is stored as DM(x,y) (S517). Then, the variable d is updated to the number increased by 1 (S518), and the processes are returned to step S508.

Constituents of the apparatus for detecting the stereo disparity in a sequential parallel processing mode as discussed above referring to FIG. 5 are explained in detail.

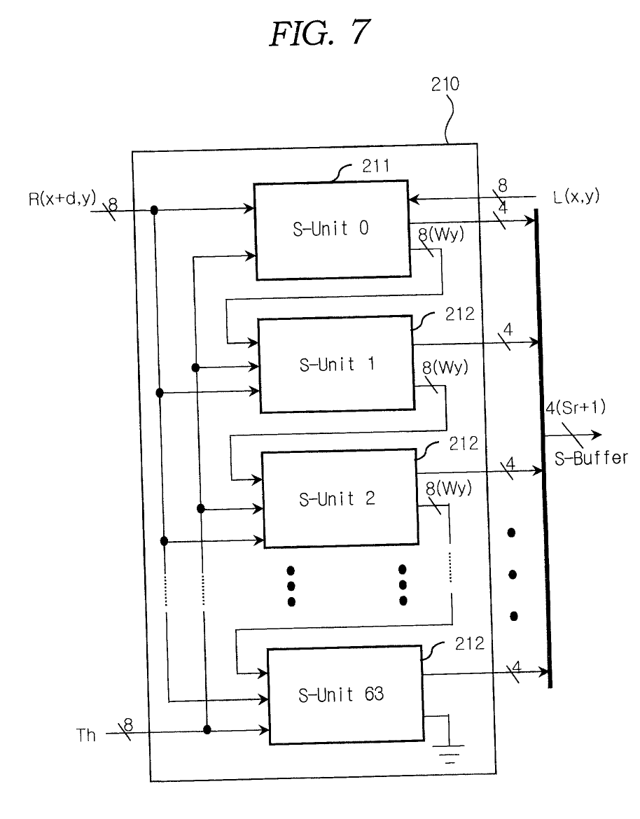

FIG. 7 shows constituents of the strip-processing unit 210. The strip-processing unit 210 consists of S-units 211 and 212, the total number of which is (Sr+1). The S-units 211 and 212 calculates P(x,y,d) of a matched scanning pixel L(x+d,y) with respect to a reference pixel R(x,y) using Equation 1, wherein the variable d varies from 0 to Sr. The results processed by the strip-processing unit 210 are accumulated to obtain the value of S of a matched scanning column W_{y}. The value of S output from the strip-processing unit 210 is stored in the S-buffer 100.

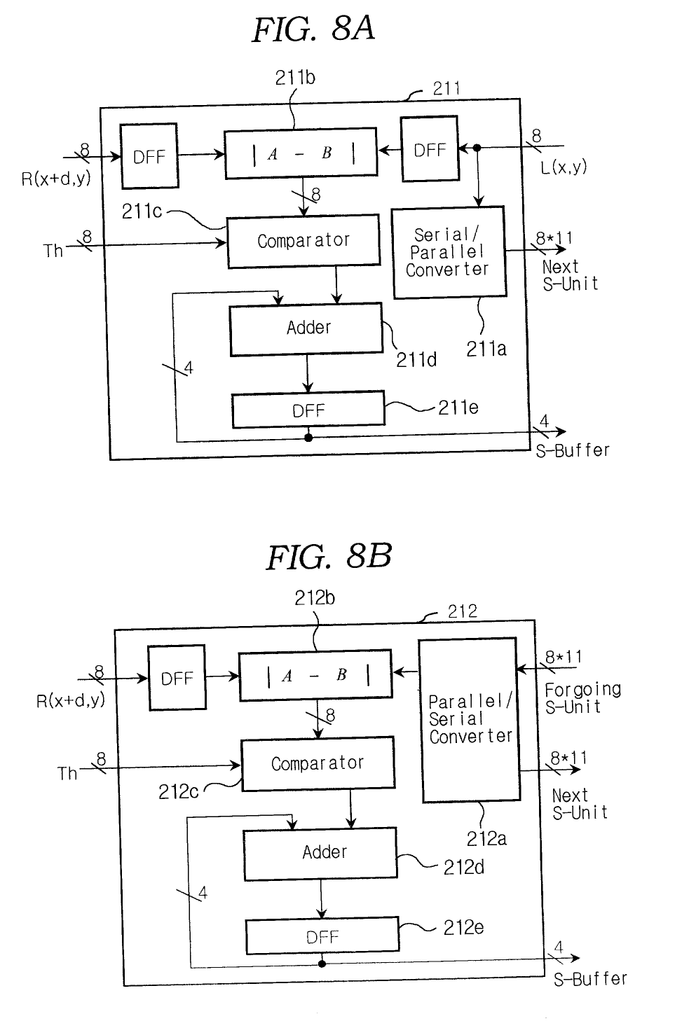

FIGS. 8A and 8B show detailed structures of S-units 211 and 212 shown in FIG. 7, respectively.

One unit of the S-units 211 is a device for calculating S of a matched scanning column, where the variable d is 63, with respect to the reference column. The S-unit 211 comprises a serial/parallel converter 211a for converting sequential data of pixel brightness into parallel signals. The parallel signals converted by the serial/parallel converter 211a are provided to another S-unit 212. A calculator 211b calculates differential brightness of a matched scanning pixel from a reference pixel. A comparator 211c outputs “0” if differential brightness calculated by the calculator 211b is greater than a threshold. Otherwise, the comparator 211c outputs “1”. An adder 211d accumulates outputs of the comparator 211c for pixels in the matched scanning column. A D-flip-flop 211e conducts buffering of the data (4-bit data) accumulated at the adder 211d to properly output to the S-buffer 100.

Another unit of the S-units 212 is a device for calculating S of a matched scanning column, where the variable d varies from 62 to 0, with respect to the reference column. The S-unit 212 comprises a parallel/serial converter 212a for converting parallel data of pixel brightness from the S-unit 211 or from the S-unit 212 in the previous stage into sequential signal. The sequential signals converted by the parallel/serial converter 212a are transmitted to the next S-unit 212. A calculator 212b calculates differential brightness of a matched scanning pixel with respect to the reference pixel. A comparator 212c outputs “0” if differential brightness calculated by the calculator 212b is greater than a threshold. Otherwise, the comparator 212c outputs “1”. An adder 212d accumulates outputs of the comparator 212c for pixels in the matched scanning column. A D-flip-flop 212e conducts buffering of the data (4 bit data) accumulated at the adder 212d to properly output to the S-buffer 100.

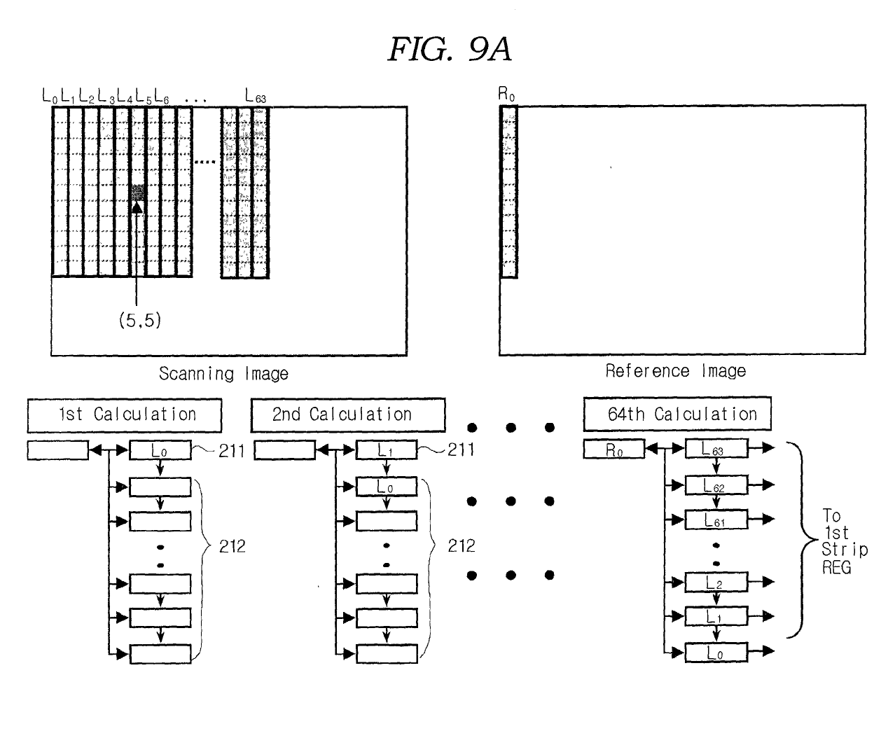

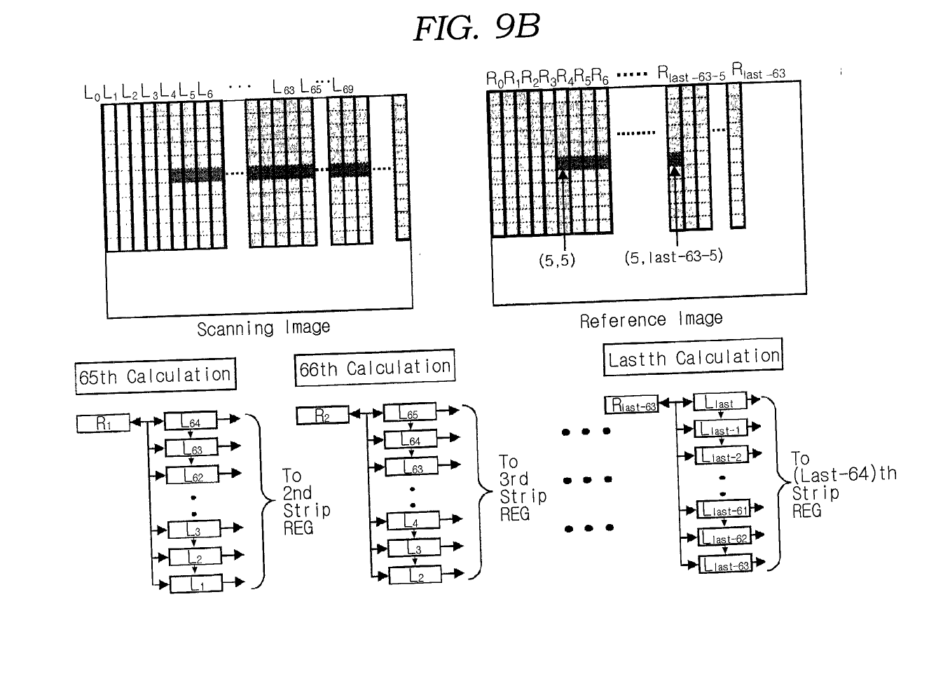

FIGS. 9A and 9B show a map including a scanning image and a reference image for explaining the operation of the strip-processing unit 210. Referring to FIGS. 9A and 9B, processes for calculating S of a matched scanning column with respect to a reference column by employing a systolic array are explained, where Wₓ=W_{y}=11, Sr=63, d=0 through 63, and wx=wy=5.

Brightness data of eleven pixels constituting a column are sequentially inputted to the S-unit 211. The serial/parallel converter of the S-unit 211 converts the brightness data of eleven pixels into parallel data arranged in a column, and then transmits the parallel data to the next S-unit.

FIG. 9A shows that sixty four (64) calculations are required from the first calculation to the sixty fourth to obtain S for all of the values of d for the first reference column. Since sixty four columns in the scanning range are sequentially inputted from the first column L₀ to the sixty fourth column, a preceding column is sequentially shifted to the next S-unit so that the sixty fourth calculation is conducted as shown in FIG. 9A when the sixty fourth matched scanning column L₆₃ is inputted. The first reference column R₀ is inputted when the sixty fourth matched scanning column L₆₃ is inputted, and then each S-unit calculates S as aforementioned referring to FIGS. 8A and 8B.

At the sixty fifth calculation and calculations thereafter, a reference column R₁ and a matched scanning column L_{i+Sr} are simultaneously inputted to calculate S for each S-unit. Each S-unit calculates the similarity of each matched scanning column L_{i+d} with respect to each reference column Rᵢ, wherein the variable d varies from 0 to 63.

At the last calculation, a reference column Rₗₐₛₜ₋₆₃ and matched scanning column Lₗₐₛₜ are inputted, whereby the similarity of matched scanning columns Lₗₐₛₜ₋₆₃ through Lₗₐₛₜ, that is, d=0 through 63, with respect to the reference column Rₗₐₛₜ₋₆₃ is obtained.

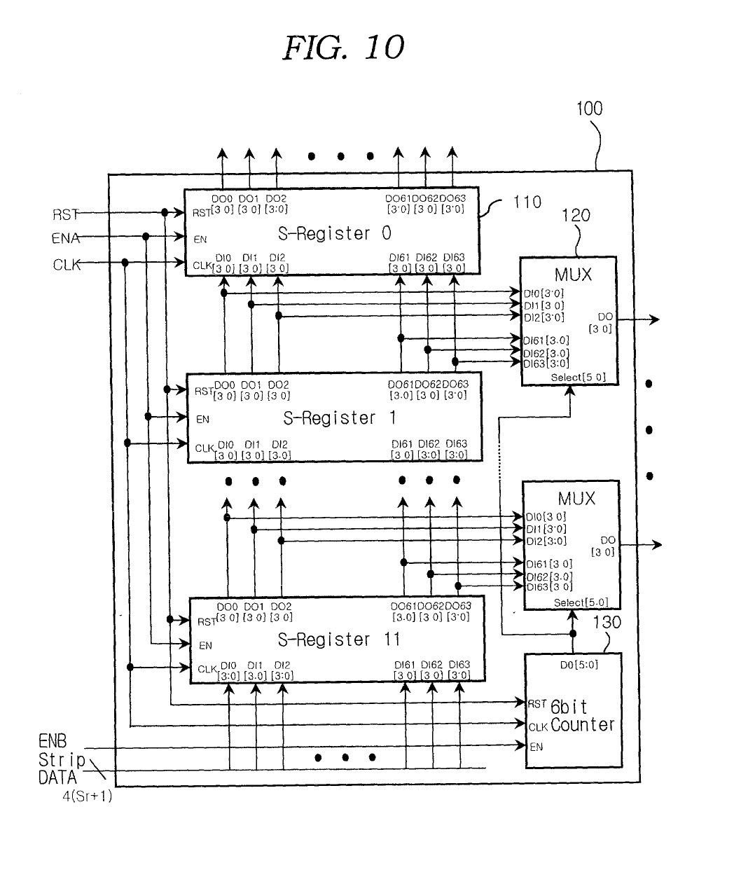

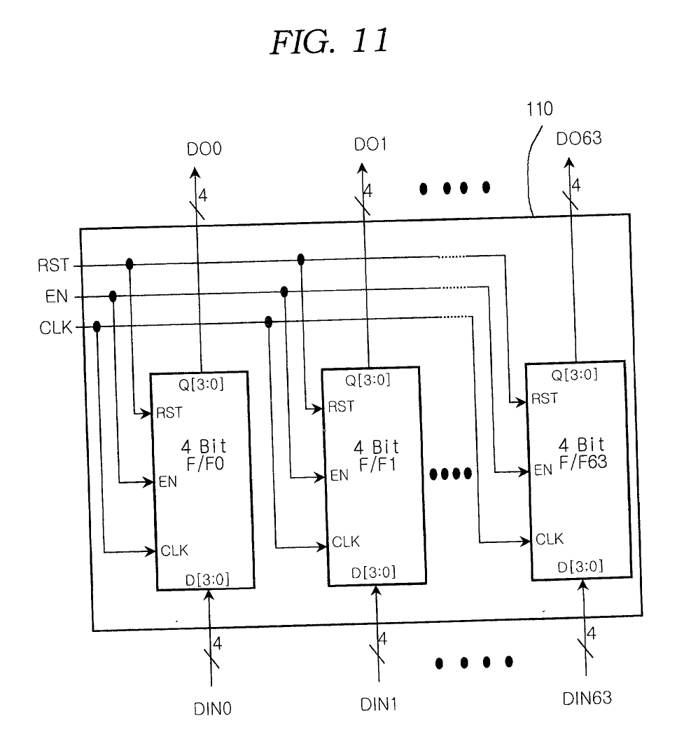

FIG. 10 shows an array of elements in an S-buffer 100 shown in FIG. 5, in which similarity of each matched scanning column with respect to the reference column is stored. The similarity of the matched scanning columns are sequentially calculated as aforementioned. FIG. 11 shows an array of elements in a S-register 110 shown in FIG. 10.

The S-buffer 100 consists of S-registers 110 to the number of (Wₓ+1), multiplexers 120 to the number of Wₓ, and a counter 130. The value of S or the number of matched scanning pixels in a matched scanning column with a size of (W_{y}+1) in vertical direction is output from each S-unit 211 or 212 of a strip-processing unit 210. In this embodiment, the value of S consists of four bits. The S-values output from S-units to the number of (Sr+1) are inputted in parallel and stored in a S-register 110. The entire S-registers 110 with a size of 4*(Sr+1)*(Wy+1) output the S-values of the matched scanning columns to the number of (Wₓ+1) by a six-bit counter. Thus, WMC of a matched scanning window is obtained. This operation of the S-buffer 100 is repeated to obtain WMCs of all matched scanning windows within the scanning range.

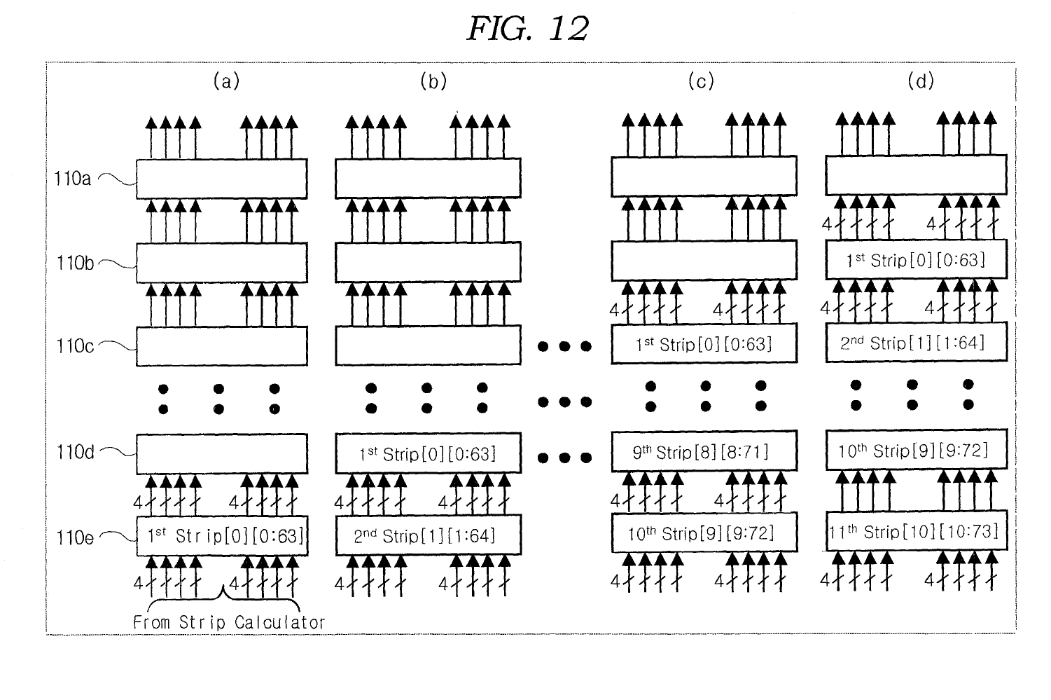

Referring to FIG. 12, operation of the S-buffer 100 will be more specifically explained. Each S-register is simply represented by a block in FIG. 12. Similarities of matched scanning columns, where d=0 63, to a reference column are inputted to the S-buffer in a systolic array method and stored in a WMC-unit.

In the sixty fourth calculation step using the strip-processing unit as shown FIG. 9A, similarities (1st Strip[0][0:63]) of matched scanning columns in the entire range of d with respect to a reference column R0 are calculated and stored in S-register 11 as referred by 110e in Column (a) of FIG. 12. In the sixty fifth calculation step using the strip-processing unit as shown FIG. 9B, similarities (2nd Strip[1][1:64]) of matched scanning columns in the entire range of d with respect to another reference column R1 are calculated and stored in S-register 11, while the similarities (1st Strip[0][0:63]) stored in step are shifted to S-register 10 as referred by 110d in Column (b) of FIG. 12. Column (c) of FIG. 12 shows the status of S-register in which ten sets of similarities for ten reference columns are inputted. Column (d) of FIG. 12 shows the status of S-register in which eleven sets of similarities for eleven reference columns are inputted.

The sum of the first S-values of matched scanning columns in the entire range of d to a reference column stored in S-registers is equal to the WMC, that is, the sum of (1st Strip[0][0]), (2nd Strip[1][1]), (10th Strip[9][9]) and (11th Strip[10][10]) is equal to the WMC(wx,y,0), while the sum of (1st Strip[0][1]), (2nd Strip[1][2]), (10th Strip[9][10]) and (11th Strip[10][11]) is equal to WMC(wx,y,1). As can be seen from Equation 3, the WMC(wx+1,y,0) is obtained by adding the value of S(wx+1+wx,y,d) to the WMC(wx,y,0) and subtracting the value of S(0,y,0) from the same.

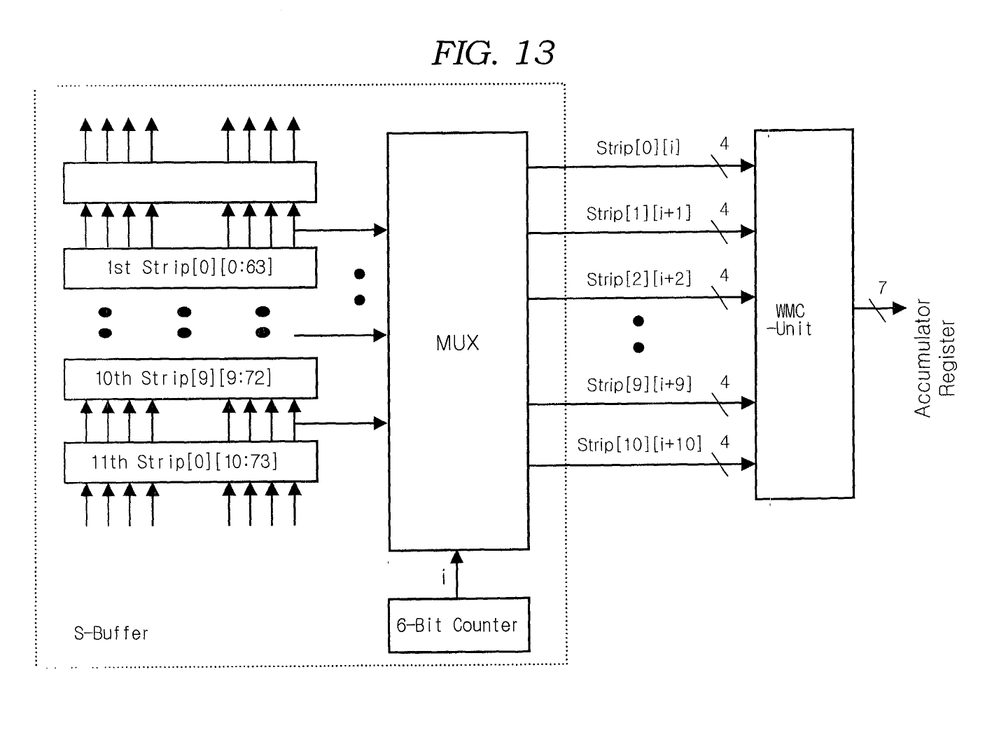

A multiplexer (MUX) of the S-buffer outputs sequentially selected one of similarities stored in the S-register to the WMC-unit as shown in FIG. 13. When similarities to the number of (Sr+1) output from the S-buffer to the WMC-unit are counted, any data is not inputted to the strip-processing unit. After process clocks (referred to a PCLK in the drawings) to the number of (Sr+1) lapsed, data of the reference image and the scanning images are inputted to the strip-processing unit.

The WMC-unit sequentially gets WMC of a matched scanning window from sequentially inputted similarities of matched scanning columns. WMC obtained by the WMC-unit is transferred to the WMC-buffer and stored in the WMC-register. A WMC-updating unit uses WMCs stored in the WMC-register to update the current WMC. A Max-WMC selection unit selects the greatest WMC and gets a stereo disparity.

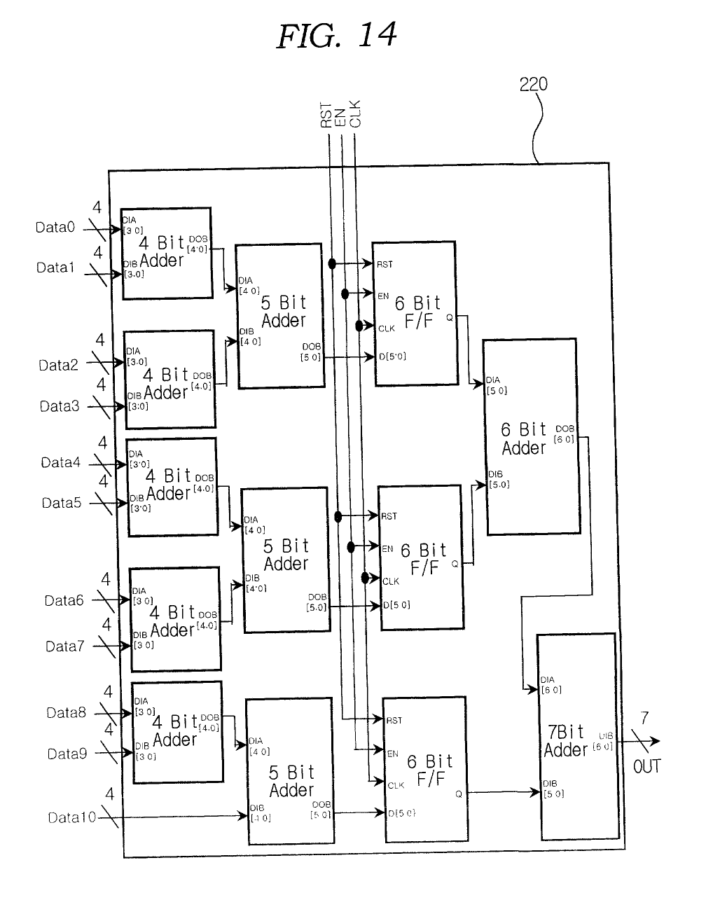

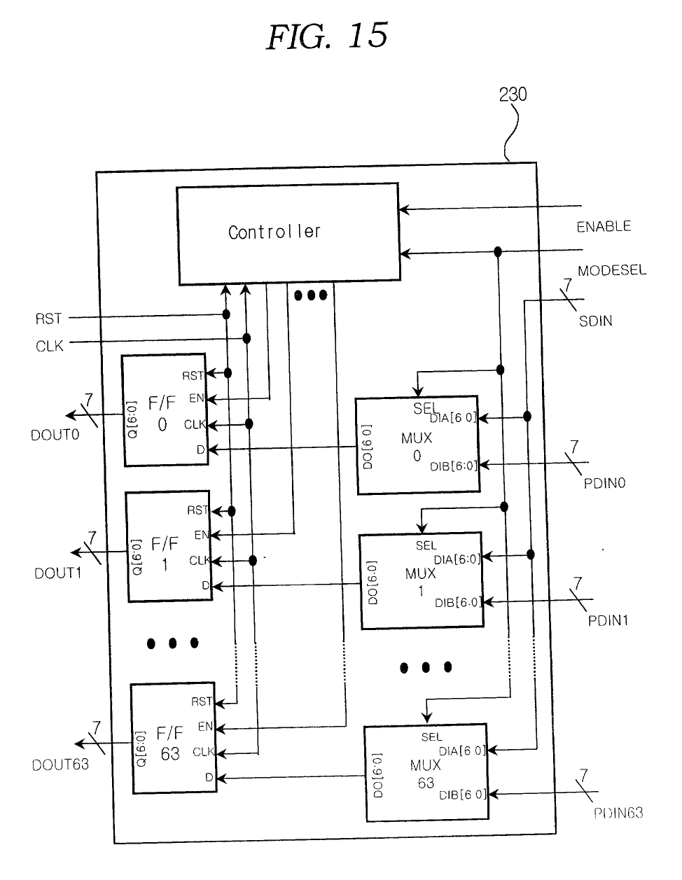

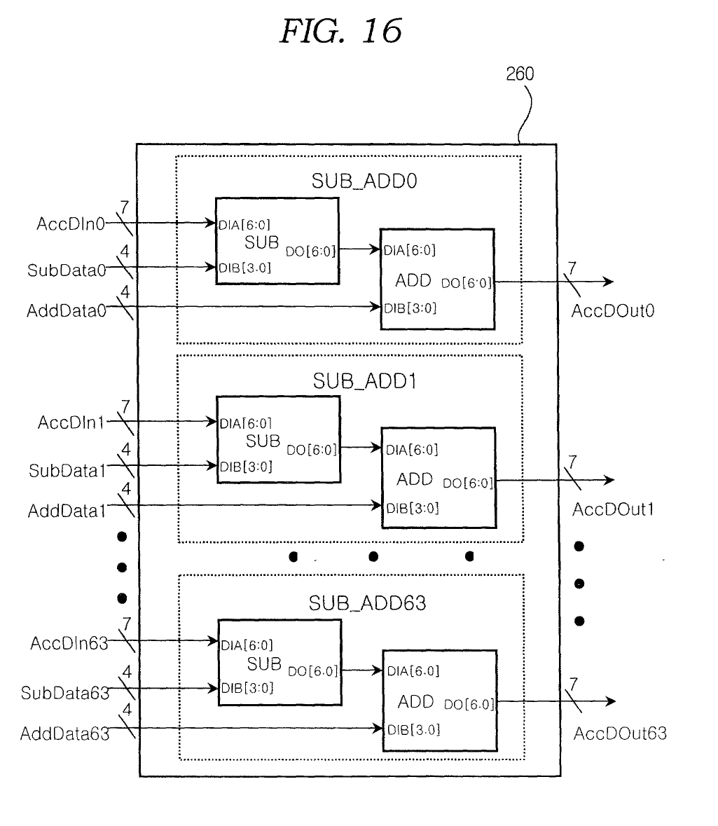

FIG. 14 shows an array of elements in the WMC-unit 220 shown in FIG. 5. FIG. 15 shows an array of elements in the WMC-buffer 230 shown in FIG. 5. FIG. 16 shows an array of elements in the WMC-updating unit 260 shown in FIG. 5. The WMC-unit 220 conducts the step designated as S515 in FIG. 6 by calculating WMCs for the variable d to the number of (Sr+1), where x=wx, and by outputting the WMCs to the WMC-buffer 230. The WMC-unit 220 consists of five 4-bit adders, three 5-bit adders, three 6-bit flip-flops, a 6-bit adder and a 7-bit adder, which are sequentially connected to one another. Ten of eleven 4-bit S-values output through the multiplexer of the S-buffer are inputted to five 4-bit adders by two at a time. Outputs from four of five 4-bit adders are inputted to two of three 5-bit adders by two at a time. Outputs from the remaining one of five 4-bit adders and remained one of eleven 4-bit S-values are inputted to the remaining one of three five-bit adders. Outputs from three 5-bit adders inputted to three 6-bit flip-flops are synchronized. The synchronized outputs from three 6-bit flip-flops are inputted to a 6-bit adder and a 7-bit adder to get the last WMC(x,y,d), and then the last value is stored in the WMC-buffer 230.

The WMC-buffer 230 stores the WMC value from the WMC-unit 220 and output of the WMC-updating unit 260 through the multiplexer in the register. The WMC values stored in the register are inputted to the WMC-updating unit 260. The WMC-buffer and the WMC-updating unit 260 cooperate to conduct the step designated as S514 in FIG. 6.

The WMC-updating unit 260 consisting of subtracters and adders to the number of (Sr+1) conducts the step designated as S514 in FIG. 6 by calculating according to Equation 3, that is, by adding the previous WMC value to the value of [S(x+wx,y,d)−S(x−1−wx,y,d)], wherein both S(x+wx,y,d) and S(x−1−wx,y,d) represent outputs of S-buffer 100, respectively. More specifically, the subtracters conduct subtraction of S(x−1−wx,y,d) from the previous WMC values AccDin0, AccDin1, . . . , or AccDin63, and the adders conducts addition of S(x+wx,y,d) to the same, by which an updated WMC(x,y,d) is obtained.

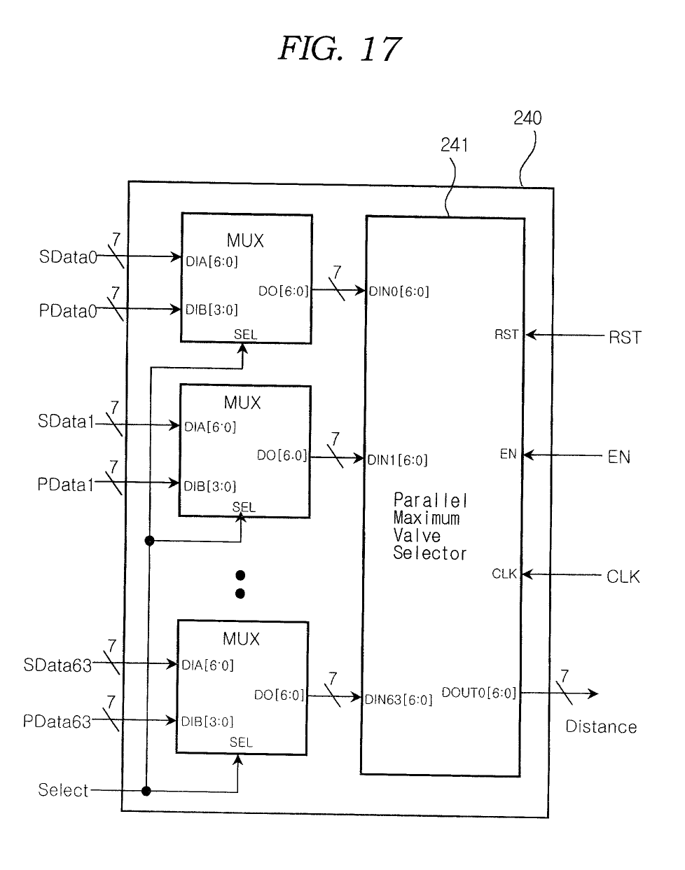

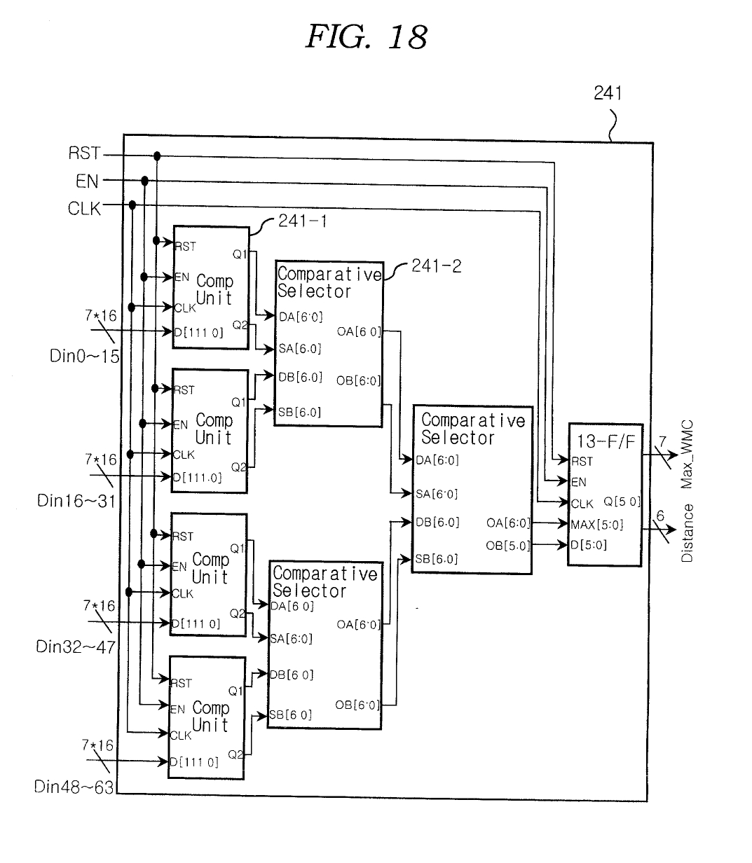

FIG. 17 shows an array of elements in the Max_WMC selection unit 240 shown in FIG. 5. FIG. 18 shows an array of elements in a parallel maximum value selector 241 shown in FIG. 17. The Max_WMC selection unit 240 consisting of the parallel maximum value selectors 241 to the number of (Sr+1) conducts comparison of WMC values with each other in a scanning sector, selection of the greatest WMC(x,y,d) and outputting DM(x,y) which is the position information of the greatest WMC(x,y,d). The parallel maximum value selector 241 consisting of four comparison units 241-1 and three comparative selectors 241-2 conducts selection of the greatest value among WMC values for matched scanning windows in scanning sectors to the number of (Sr+1), and output the position information of the greatest WMC.

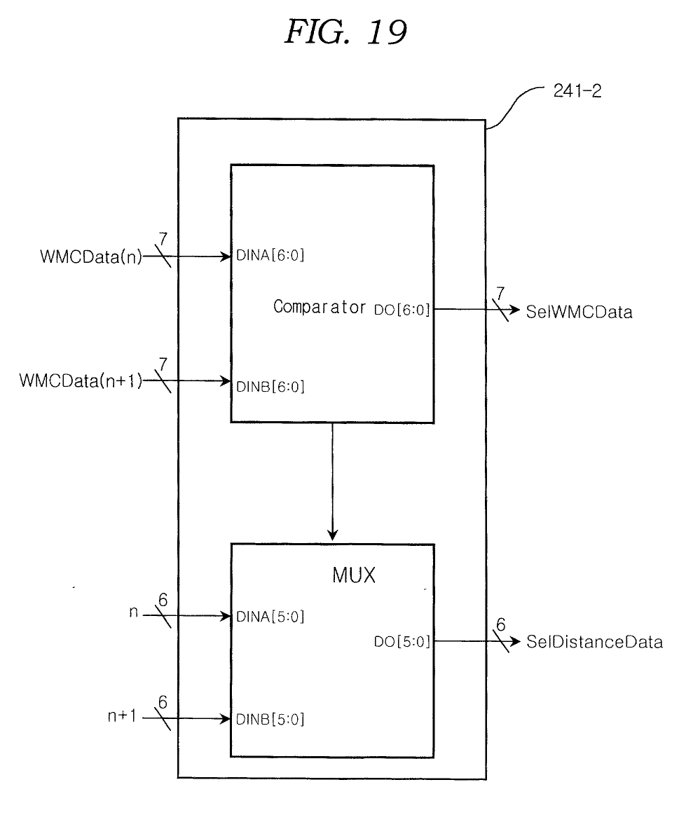

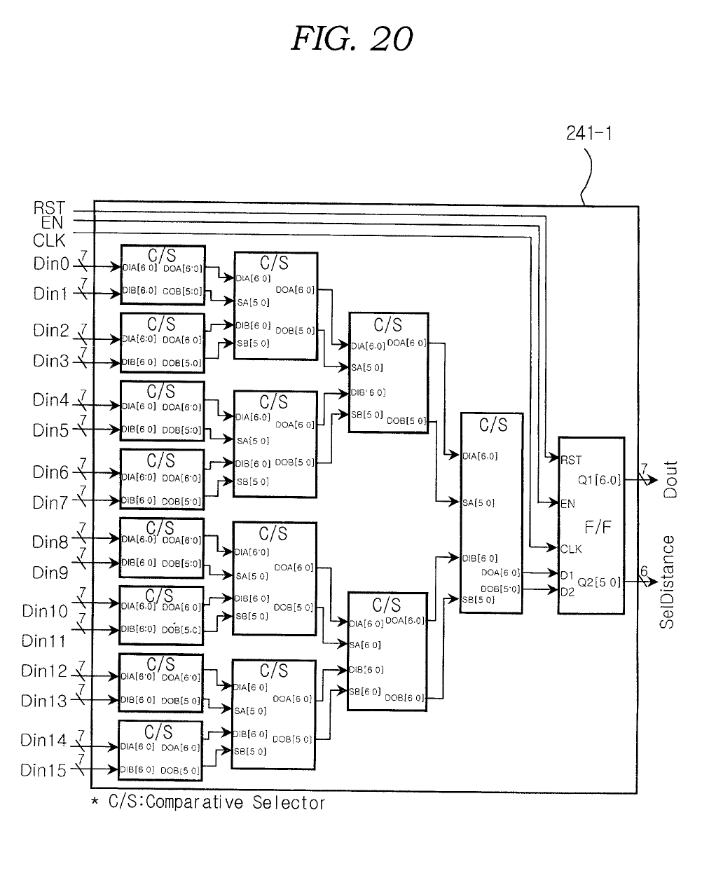

FIG. 19 shows an array of elements in the comparative selector 241-2 shown in FIG. 18. FIG. 20 shows an array of elements in the comparison unit 241-1 shown in FIG. 18. The comparison unit 241-1 consisting of the comparative selectors 241-2 and registers conducts outputting the greatest WMC value and its position information for sixteen seven-bit inputs. The position information of the matched scanning-window and the greatest WMC(x,y,d) for scanning sectors to the number of (Sr+1) are simultaneously output through each comparative selector 241-2. Thus, the value output from the last comparative selector is the greatest WMC value for a given pixel R(x,y) and a disparity thereof.

The inventive method and apparatus for detecting stereo disparity in a sequential parallel processing mode enable to detect similarities by accumulating WMC, that is, the numbers of matched scanning pixels having similar brightness in a matched scanning window without directly using absolute brightness of pixels in a scanning field. Thus, it is able to prevent from exceeding a boundary in estimating a stereo disparity.

While the invention has been described in conjunction with preferred embodiments, it is evident that many alternatives, modifications and variations will be apparent to those skilled in the art in light of the previous description. Accordingly, it is intended to embrace all such alternatives, modifications and variations as fall within the spirit and scope of the appended claims and equivalents.

What we claim is:

1. An apparatus for detecting a stereo disparity between a scanning image and a reference image based on similarities measured by counting the number of pixels having lower differential brightness than a threshold in matched scanning windows, the matched scanning windows being respectively centered at a scanning pixel within a scanning range, the matched scanning window having the same size with a reference window centered at a reference pixel, the scanning range being defined by the constraint related to image-picturing conditions, and the differential brightness being obtained by comparing the brightness of each pixel in each scanning window to that of each pixel in the reference window, characterized by comprising:
a strip-processing unit for calculating in parallel the similarities of matched scanning columns in the scanning range with respect to a reference column centered at the reference pixel;
an S-buffer for storing the similarities calculated by said strip-processing unit;
a WMC-unit for calculating the window matching count (WMC) values of matched scanning windows in the scanning range with respect to the reference window using the similarities of the matched scanning columns stored in said S-buffer; and
a Max_WMC selection unit for selecting the greatest value among the WMC values calculated by said WMC-unit to generate a shift from the scanning pixel corresponding to the reference pixel to the center pixel of the matched scanning window associated with the greatest WMC value as a disparity mark of the stereo disparity.

2. The apparatus according to claim 1, characterized by further comprising a WMC-updating unit for updating the WMC value of the current matched scanning window using the WMC value of the previous matched scanning window calculated by said WMC-unit and the similarities of the matched scanning columns stored in said S-buffer.

3. The apparatus according to claim 1 or 2, characterized in that said strip-processing unit comprises a plurality of S-units connected in parallel with each other, and brightness data of the matched scanning columns less than the number of said S-units can be inputted to a first S-unit and sequentially shifted to the next S-unit up to the last S-unit, and wherein said S-units calculate the similarity of each matched scanning column with respect to the reference column using differential brightness of pixels.

4. The apparatus according to claim 3, characterized in that said first S-unit comprises:
a serial/parallel converter for converting serial brightness data of pixels on the matched scanning column into parallel data output to the next S-unit;
a differential-brightness processing unit for obtaining differential brightness of pixels between the matched scanning column and the reference column;
a comparator for comparing the differential brightness of pixels obtained by said differential-brightness processing unit to a threshold value;
an adder for accumulating outputs of pixels from said comparator; and
a D-flip-flop for buffering outputs from said adder into said S-buffer.

5. The apparatus according to claim 3, characterized in that each of said S-units other than said first S-unit comprises:
a parallel/serial converter for converting parallel brightness data of pixels of the matched scanning column into serial data output to the next S-unit;
a differential-brightness processing unit for obtaining differential brightness of pixels between the matched scanning column and the reference column;
a comparator for comparing the differential brightness of pixels obtained by said differential-brightness processing unit to a threshold value;
an adder for accumulating outputs of pixels from said comparator; and
a D-flip-flop for buffering outputs from said adder into said S-buffer.

6. The apparatus according to claim 2, characterized in that said S-buffer comprises:
(Wₓ+1) units of S-registers for sequentially shifting the (Sr+1) similarities inputted from said strip-processing unit;
Wₓ units of multiplexers for multiplexing outputs of said S-registers; and
a counter for counting the similarity data inputted to said S-register to output multiplexing control signals to said multiplexers, wherein Wₓ is the number of pixels in a horizontal row of the matched scanning window, and the value of Sr being obtained by subtracting the value of wx form the number of pixels in a horizontal row of the scanning range where
$$wx = \frac{{W}_{x} - 1}{2} .$$

7. The apparatus according to claim 6, characterized in that said WMC-unit comprises:
an adder for accumulating the similarities multiplexed by said multiplexers to output the WMC value.

8. The apparatus according to claim 2, characterized in that said WMC-updating unit comprises:
a subtracter for subtracting the similarity of the foremost column of the previous matched scanning window from the WMC value of the previous matched scanning window; and
an adder for adding the similarity of the rearmost column of the current matched scanning window to the WMC value of the previous matched scanning window to obtain the WMC value of the current matched scanning window.

9. A method for detecting a stereo disparity between a scanning image and a reference image based on similarities measured by counting the number of pixels having lower differential brightness than a threshold in matched scanning windows, the matched scanning windows being respectively centered at a scanning pixel within a scanning range, the matched scanning window having the same size with a reference window centered at a reference pixel, the scanning range being defined by the constraint related to image-picturing conditions, and the differential brightness being obtained by comparing the brightness of each pixel in each scanning window to that of each pixel in the reference window, characterized by comprising the steps of:
processing in parallel the similarities of all matched scanning columns centered at the scanning pixels in the scanning range to a reference column centered at the reference pixel;
calculating the window matching count (WMC) values of all matched scanning windows with respect to the reference window using the similarities parallel processed in said column similarity processing step; and
selecting the greatest WMC and generating a shift from the scanning pixel corresponding to the reference pixel to the center pixel of the matched scanning window associated with the greatest WMC value as a disparity mark of the stereo disparity.

10. The method according to claim 9, characterized in that said column similarity processing step comprises sub-steps of:
obtaining differential brightness between a reference pixel in the reference column and a scanning pixel matched to the reference pixel;
counting the number of pixels having differential brightness lower than a threshold in the matched scanning column; and
setting the number of pixels counted in said pixel counting sub-step as the similarity of the matched scanning column.

11. The method according to claim 9, characterized in that said WMC value calculating step comprises a sub-step of calculating the WMC values between the matched scanning windows and a reference window including the foremost column in the reference image using the equation below:
$$WMC ( x , y , d ) = {\sum }_{i = - wy}^{wy} S ( x + i , y , d )$$
wherein, wy represents (W_{y}−1)/2 and W_{y} represents the number of pixels in a column of the scanning window.

12. The method according to claim 9, characterized in that said WMC value calculating step comprises a sub-step of calculating the WMC values between the matched scanning windows and another reference window not including the foremost column in the reference image using the equation below:
WMC(x,y,d)=WMC(x−1,y,d)+S(x+wx,y,d)−S(x−1−wx,y,d)
wherein, wy represents (W_{y}−1)/2 and W_{y} represents the number of pixels in a column of the scanning window.
